(19) United States
(12) Patent Application Publication
(10) Pub. No.: US 2011/0022266 A1
(43) Pub. Date: Jan. 27, 2011

(54) VEHICLE-SUSPENSION SYSTEM WITH REMOTE CONTROL

(76) Inventors: Luigi Piero Ippolito, Pianezza (Torino) (IT); Massimo Seminara, Asti (IT); Giordano Greco, Torino (IT)

Correspondence Address: BLISS MCGLYNN, P.C., 2075 WEST BIG BEAVER ROAD, SUITE 600, TROY, MI, 48084, US

(21) Appl. No.: 12/921,323

(22) PCT Filed: Dec. 24, 2008
(86) PCT No.: PCT/IB08/55528

§ 371 Date: Sep. 7, 2010

(30) Foreign Application Priority Data
Mar. 5, 2008 (IT) TO2008A000168

(51) Int. Cl. B60G 17/018

(52) U.S. Cl. 701/37

(57) ABSTRACT

A control system of dynamics of a vehicle includes a processing and control electronic unit (10) arranged to adjust predetermined parameters of at least one control function. An on-board telematics platform (30) is connected to the processing and control electronic unit (10) and adapted to establish a communication link (L) with an autonomous portable personal electronic device (T) arranged to allow inputting adjustment data of the control function. The processing and control electronic unit (10) is arranged to assume a first autonomous operative condition wherein the processing and control electronic unit (10) is adapted to implement applications based on resident control strategies and a second coupled operative condition wherein the processing and control electronic unit (10) is adapted to establish communication with the telematics platform (30) to receive the adjustment data emitted by the portable personal electronic device (T) and implement the control function based on the adjustment data received.

### CROSS-REFERENCE TO RELATED APPLICATIONS

This application claims benefit of PCT Patent Application PCT/IB2008/055528 entitled “CONTROL SYSTEM OF A VEHICLE DYNAMICS, WITH ADJUSTMENT CHARACTERISTICS OF THE CONTROL PARAMETERS TUNABLE NY THE USER” and filed on Dec. 24, 2008, which claims benefit of TO2008A000168 (Mar. 5, 2008).

### BACKGROUND OF INVENTION

1. Field of Invention

The present invention generally relates to control systems of a vehicle dynamics and more specifically to the adjustment of such control systems as a function of the particular operative condition of the vehicle or the position of the same vehicle on a predefined travel route.

2. Description of Related Art

Nowadays, control systems of a vehicle dynamics are more and more often used, especially in the automotive field, which are able to vary the characteristics of the function which is managed under the control of an electronic control unit as a function, for example, of the road surface conditions, the vehicle gear conditions, the comfort settings desired by the driver.

For example, with reference to a suspension system of the vehicle, the vertical movements of a vehicle body, and more generally the vehicle vertical dynamics, are affected by the road surface conditions and the maneuvers imparted by the driver, such as the steering, acceleration, braking, gear ratio shift maneuvers.

A semi-active suspension system generally comprises:
shock absorbers with adjustable damping, for example, of the type including a pressure chamber containing a damping fluid (oil), inside of which a piston is slidable, the position of which defines a lower pressure chamber and an upper pressure chamber, a by-pass chamber communicating with the upper pressure chamber via fluid through-holes, and a control valve, typically a solenoid-valve, so arranged as to control the passage of the damping fluid between the pressure chamber and the by-pass chamber;
a set of sensors adapted to detect the relative acceleration or the relative movement between the vehicle body and the wheels hub, arranged at the vehicle front and rear axes; and
a processing and control electronic unit, adapted to receive and interpret the signals emitted by the sensors, indicative of the vehicle dynamics, and so arranged as to emit driving signals of the control valves of the system shock absorbers in order to track the desired “damping” characteristics of the shock absorbers, with the aim of implementing a determined performance of the vehicle dynamics and of implementing specific filtering out requirements of the road irregularities.

Typically, the control logics of the suspension system is of a modular type, thereby it is controlled according to one of a multiplicity of predefined control strategies as a function of the detected conditions of the road surface, the vehicle lateral dynamics, the “damping” characteristic model set up and/or desired by the user, according to predetermined priority rules in view of keeping the running vehicle in a safety condition.

The adjustment of the shock absorbers “damping” characteristics is carried out by the control unit by emitting an electric signal for driving of the actuating means controlling the shock absorber. In this manner, it results to be possible to continuously adjust the “damping force” characteristic as a function of the relative translational speed between wheel assembly and vehicle body (“F/v” characteristic), for each individual shock absorber. Compared to the passive suspension systems, in which the “damping” characteristic (F/v) is determined by the mechanical and physical parameters of the shock absorber and the “damping fluid viscosity” characteristics, and is represented by a single given curve on which the shock absorber operational point is located, a semi-active suspension system defines a scatter of operational points belonging to different damping curves (F/v) covering an operational area included between a minimum “damping” characteristic and a maximum “damping” characteristic.

In given “ride” conditions such as, for example, when driving a vehicle on a predefined route (for example, a racing track) a driver may require sporting performance to the vehicle which also depend on the “suspension system” characteristics. Therefore, he may desire a more free and personal setting of the “damping control” characteristics of the suspension system, different from the ones which would be decided by the control unit based on the predefined strategies. For example, the driver may require customizable settings of the “damping control” characteristics, dictated by subjective ride capabilities. Furthermore, he may need settings that are function of the vehicle localization on the route, and the particular characteristics of the road surface.

Currently, such “customization” function is not provided, except for the very limited form of a selection of one from a limited number of predefined adjustment modes of the suspension system, for example, characterizing a speeding or a comfortable driving. This is a direct consequence of the fact that there is no user interface present which allows the multilevel customization of the calibrations of the suspension system control logics, therefore the user can only rely on predefined settings.

Similarly, with reference, for example, to a traction control system, consumptions and ride comfort are affected by the ride conditions and the maneuvers maneuver imparted by the driver.

A traction control system generally comprises:
actuating means with adjustable parameters, for example, for the propulsion control (fuel injection, ignition timelines, timing and lift of the suction and exhaust valves, over-boost), or for the shifting control (selection of the gear ratios, timelines of the gear shifts, management of the torque transmitted by the clutch, etc.);
a set of sensors adapted to detect the vehicle operative conditions and the commands imparted by the driver, for example, through the accelerator pedal or gear ratio selector means; and
one or more processing and control electronic units, adapted to receive and interpret the signals or data emitted by the sensors, and so arranged as to emit driving signals of the actuators in order to track the desired control characteristics with the aim of implementing the vehicle traction requirements, pursuing specific targets of comfort, performance, consumptions, and pollution emissions.

The vehicle traction adjustment is carried out by the control units, arranged to this aim by driving the electro-actuators adapted to adjust specific parameters of the drivetrain and the speed shift, such as injection, ignition, timing and lift of the suction and exhaust valves (where applicable), “over-boost” function (where applicable), ratios selection, gear shift timelines, and management of the torque transmitted by the clutch.

In given ride conditions such as, for example, when driving a vehicle on a predefined route (for example, a racing track), a driver may require performance to the vehicle which depend on the “motor control” or “gear ratio” characteristics. Therefore, he can desire a more free and personal setting of same of all the characteristics listed in the preceding paragraph, requiring adjustment actions which are different from those ones which would be decided by the control units based on the predefined strategies. For example, the driver may require customizable settings dictated by subjective “ride” capabilities. Furthermore, he may need settings which are functions of the vehicle localization on the route.

Currently, neither such function is provided, except for the very limited form of a selection of one from a limited number of predefined “adjustment” modes, for example, characterizing a speeding driving or a consumption containment.

An object of the present invention is to provide a vehicle “dynamics control” system which allows the user a wider customization of the settings of the “dynamics control” function which is being managed.

In particular, in the application for the control of a suspension system, an object of the invention is to provide a system which allows the user a wider customization of the settings of the “damping control” characteristics of the shock absorbers.

More generally, the invention is to be intended as extended to other “control” systems of a vehicle dynamics, such as, for example, “control” systems of traction (motor and transmission control), steering, and braking action.

In the application for the control of a “motor control” system, an object of the invention is to provide a system which allows the user a wider customization of the main control settings, such as “injection adjustment” settings, ignition, timing and lift of the valves (where applicable), “over-boost” function (where applicable), and other ones.

In the application for the control of a “gear ratio control” system, an object of the invention is to provide a system which allows the user a wider customization of the main control settings, such as the “ratios selection” settings, the gear shift timelines, and the management of the torque transmitted by the clutch.

In the application for the control of a “steering or braking action control” system, an object of the invention is to provide a system which allows the user a wider customization of the relative control settings, such as the settings of adjustment of the effort required to actuate the steering and the brake pedal, and adjustment of the intervention readiness and precision of the same.

### SUMMARY OF INVENTION

The present invention overcomes the disadvantages in the related art in a suspension system for a vehicle including a plurality of shock absorbers with adjustable damping each of which is provided with a control valve to control passage of a damping fluid between chambers of the shock absorber to modify relative damping force. A set of sensors is adapted to detect relative acceleration or movement between a body of the vehicle and wheel hubs arranged at front and rear axes of the vehicle. A processing and control electronic unit emits driving signals of the control valves as a function of at least signals of the set of sensors indicative of dynamics of the vehicle based on predetermined control strategies. The processing and control electronic unit assumes a first autonomous operative condition in which the processing and control electronic unit is adapted to implement applications based on resident control strategies and a second coupled operative condition in which the processing and control electronic unit is adapted to establish a communication according to a first predetermined transmission protocol with an on-board telematics platform adapted to establish a communication link through a second predetermined transmission protocol with an autonomous portable personal electronic device and provided with respective input and output interface devices to allow inputting adjustment data of at least one damping force characteristic of the shock absorbers. The processing and control electronic unit in the second coupled operative condition is adapted to receive the adjustment data and drive the control valves based on the adjustment data received, and the suspension system is adapted to implement a control system.

The present invention is based on the principle to provide access to the control unit of a vehicle “dynamics control” system, for example, the suspension system, the motor control system, the transmission control system, and the steering and braking action control systems, in a controlled manner, via the human-machine interface implemented by a multi-medial telematics system integrated in the vehicle, interfaced with the “CAN” or FlexRay® network, Lin, serial, wireless, Bluetooth®, or similar on-board cabling, operating according to a specific pre-established transmission protocol. Such access to the vehicle “dynamics control” system allows the user to modify the main calibrations according to a personal and wider control mode.

The market of the information and telecommunication personal electronic devices, such as, for example, smart-phones, PDA, and PND (Personal Navigation Devices) portable navigators, is more and more widespread among consumers, and these devices are carried along by the owners also on board of their vehicles, where it is often desired to keep on using them, in respect of the safety conditions when driving. The relative infotelematic applications can interact in an integrated mode with an on-board multimedia telematics system via a wireless connection system, for example, according to the Bluetooth® protocol.

In the example of the control of a suspension system of the vehicle, via a mobile personal device and a specific applicative program, it is possible to send adjustment commands to the suspension system control unit, which the unit autonomously interprets for the actuation of the shock absorbers control valves.

Advantageously, such commands can also be associated to localization information of the vehicle on a given route, obtainable, for example, from a personal navigation device, which only relies on its own satellite positioning information, or an on-board integrated satellite navigation system, in order to create a mapping of the calibrations and/or actuation commands of the suspension system as a function of the same route travelled by the vehicle, for example, a route frequently travelled or a competition track.

Suitably, the user can set the adjustment parameters within a range of values which ensure the safeguard of the safety conditions during the vehicle maneuvers under each operative condition.

In the case of the application to a “suspension” system, the system according to the invention can be installed on board of the vehicle in an “original equipment” configuration or an “after-market” configuration.

In the first case, the control unit of an original semi-active “suspension” system is first connected to the sensors provided on the hubs and the vehicle body, as well as the adjustable damping shock absorbers, and—through the original “CAN” network (or FlexRay®, Lin, serial, wireless, Bluetooth®, or similar on-board cabling)—to an integrated multimedia telematics platform.

In the second case, as an alternative, the arrangement of a control unit provided with integrated sensors, for example, accelerometer sensors, adapted to identify the vehicle dynamics and the simple replacement of the pre-existent passive shock absorbers with semi-active shock absorbers, the control valves of which are adapted to be driven by the same control unit, is provided. The multimedia telematics platform can be already provided on board, or installed along with the control unit, optionally integrated therein, and coupled to the control unit via a dedicated “CAN” network (or FlexRay®, Lin, serial, wireless, Bluetooth®, or similar cabling).

Other objects, features, and advantages of the present invention will be readily appreciated as the same becomes better understood while reading the subsequent description taken in conjunction with the accompanying drawings.

### BRIEF DESCRIPTION OF EACH FIGURE OF DRAWING OF INVENTION

FIG. 1 shows a block diagram illustrating a schematic representation of a first embodiment of the architecture of an active or semi-active “suspension” system, arranged for tuning by a user, according to the invention;

FIG. 2 shows a block diagram illustrating a schematic representation of a second embodiment of the architecture of an active or semi-active “suspension” system, arranged for tuning by a user, according to the invention; and

FIG. 3 shows a series of diagrams representative of the “damping control” characteristics of the vehicle “suspension” system which is the subject of the invention, as a function of length sections of a predetermined path.

### DETAILED DESCRIPTION OF EMBODIMENTS OF INVENTION

In the figures, like elements having corresponding characteristics or functions are indicated with the same reference numerals. Herein, a “vehicle” is a car of any kind provided with wheels and autonomous propulsion, driven by man, and adapted to road-transport of persons, animals, and objects. Particularly, the invention is described with reference to an active or a semi-active suspension system for the vehicle, but the invention is equally applicable to other control systems of dynamics of the vehicle in a broad sense, such as control systems for traction (propulsion, transmission), steering, and braking action.

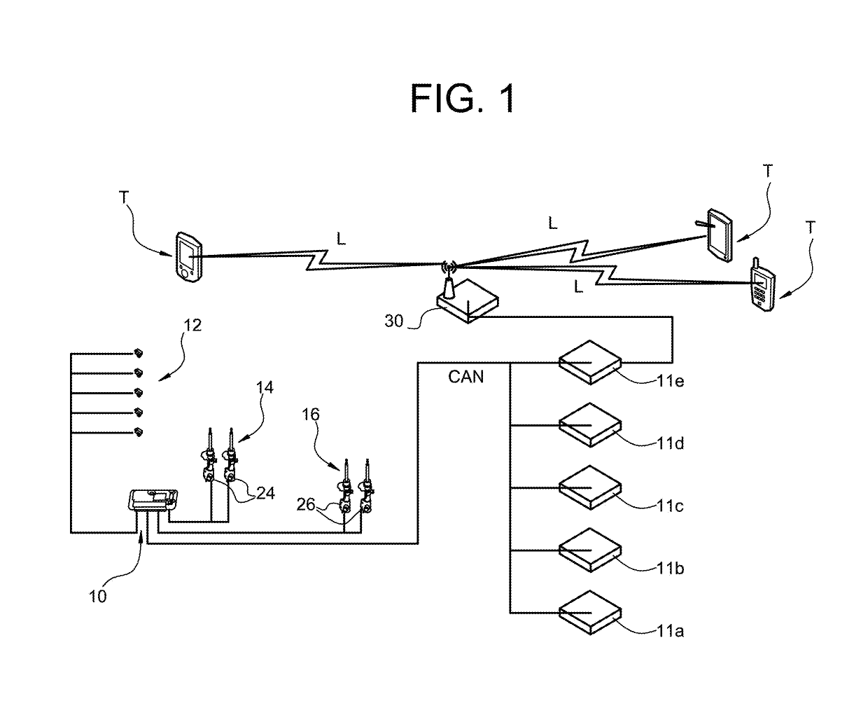

FIG. 1 represents an original equipment configuration of the system which is the subject of the invention. A suspension system control unit 10 is shown as interfaced with a “CAN” bus (or FlexRay®, Lin, serial, wireless, Bluetooth® or similar on-board cabling) of an on-board network of the vehicle, to which other on-board control units are connected, such as, typically, a motor control unit 11a, a transmission control unit 11b, a vehicle longitudinal dynamics control unit arranged for the management of the “ABS,” “EBD,” and “ASR” functions during the braking or acceleration maneuvers 11c, a vehicle lateral dynamics control unit arranged for the management of the steering maneuvers 11d, and a control unit of the interior compartment and bodywork devices, usually identified as the “body computer” 11e.

The unit 10 is coupled to sensors generally indicated with 12, including accelerometers associated to the vehicle body and the hubs of the wheels at least one vehicle axis, preferably the front axis, adapted to detect the relative acceleration or the relative movement between vehicle body and wheels hub. In a simplified embodiment, the control unit 10 can integrate accelerometer sensors on its own circuit board, so as not to require additional connections on board of the vehicle, preferable in the case of an “after-market” installation.

With 14 and 16 the front and rear shock absorbers of a vehicle, respectively, are indicated, and with 24 and 26 the relative actuators devices for the control of the damping characteristics, in particular pulse with modulated, current driven solenoid-valves.

With 30 a gateway interface device is indicated, for example, belonging to an on-board original equipment multimedia telematics platform, including a communication module to establish a link “L” for transmitting data according to an infrared, serial, USB, or “wireless” mode connection, preferably according to a Bluetooth® or wi-fi protocol, with an external personal information and telecommunication terminal device “T,” such as a palmtop computer, a mobile phone with “data management” functions (Smartphone), and a personal navigation device. The gateway device 30 is currently so arranged as to forward data between the external device “T” and an on-board control unit (for example, the body computer 12) interfaced with the “CAN” network (or FlexRay®, Lin, serial, wireless, Bluetooth® or similar on-board cabling) for the integration of on-board “telematics” functions, such as “telephonic,” “audio reproduction,” and “navigation” functions. It operates by converting the signals received from the external device “T” according to a first transmission protocol into control signals which can be transmitted on the on-board network according to the relative common transmission protocol, and vice versa.

In a preferred embodiment, the gateway device 30 is adapted to perform the Bluetooth®/“CAN” “interface” function, and the mobile personal device “T” is a portable navigation device, including (according to the prior art) a satellite positioning module (for example, a GPS receiver), a database of reference cartographic representations (road maps), a processing module for the computation of navigation data (trajectory), and input/output user interface modules, for example, a keypad terminal, a display, and the like.

The portable navigation device “T” is adapted to autonomously perform the “navigation” functions, and in particular to determine the current geographical position thereof via its own satellite positioning module.

According to the communication protocol employed, for example, the Bluetooth® protocol, one from the device “T” and the gateway 30 is provided with recognition means for the presence of the other device within a predetermined communication operative range, for example, having an order of magnitude of the dimension of the same vehicle or the interior compartment thereof.

A vehicle user can set the desired suspension system “damping control” characteristics by setting or modifying predetermined parameters representative of such characteristics, by acting on an input interface (keypad, touch screen, etc.) of the personal device “T,” and optionally locally storing one or more personal tuning profiles.

Through the connection of the device “T” to the gateway 30, the data can be transmitted to the vehicle and sent via the “CAN” network (or FlexRay®, Lin, serial, wireless, Bluetooth® or similar on-board cabling) to the suspension system control unit 10, which locally stores them in place of the predefined or currently computed values.

Then, the control unit 10 operates the adjustment and management of the vehicle suspension system according to the received data.

Suitably, the tuning profile set by the user can be associated to navigation data, such as specific segments of a pre-established path, also provided by the device “T,” by means of a map stored in the system “T” during a learning step. During the ride, the control unit 10 is so arranged as to receive in real time from the device “T” the settings of the suspensions control system stored in the map, so as to consequently modify the vehicle behaviour behavior. The solution according to the invention finds its preferred use in the customized tuning of a vehicle suspension system on a competition track, thereby it is possible to set preferred values of the shock absorbers “damping” characteristic as a function of the track length section travelled and to automatically recover such settings in a predictive and automatized manner during the ride on the route.

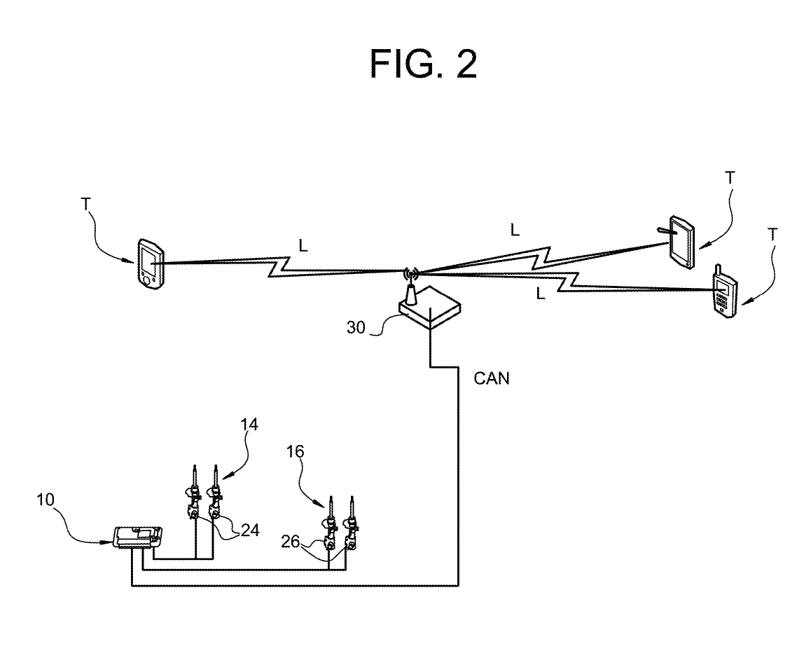

FIG. 2 represents an after-market configuration of the system which is the subject of the invention, in which the control unit 10 is installed afterwards, and it is coupled to the gateway device 30 through a dedicated “CAN” network (or FlexRay®, Lin, serial, wireless, Bluetooth® or similar cabling).

Advantageously, in an autonomous embodiment, it is possible to directly integrate the gateway device 30 with the control unit 10, providing a “wireless” interface module therein with external devices, independently from the presence of an on-board original equipment multimedia telematics platform.

By way of non-exhaustive example only, some different customization levels of the control settings of the shock absorbers damping level which the system can allow are set forth below. The thus-implemented “customization” function is indicated herein as “Custom Tuning Management”.

A first customization level, called “Manual Mode”, consists in the possibility, by the user, of selecting a particular force-speed curve of the single shock absorber of the suspension system.

In a second customization level, called “Preset Mode”, the vehicle shock absorbers assembly is automatically adjusted in real time by the suspension system “processing and control” unit, based on different control strategies, each of which is so devised as to privilege a particular aspect of the vehicle dynamics under particular operative conditions. The user can select a particular control configuration, so as to privilege one of these aspects of the vehicle dynamics. For example, “Comfort” and “Sport” control configurations can be provided (which privilege, respectively, the ride comfort and the speeding), an “Off-Road” configuration (aimed to the shock absorbers management on dirt roads), an “Ice/Snow” configuration (dedicated to the management of the shock absorbers in presence of ice or snow), and other ones.

A third customization level, called “Track Mode,” allows the user to divide a preset path in elementary segments and associate a particular control configuration of the vehicle shock absorbers assembly to each of them. It shall be apparent that this function is only available in the case where the device “T” is a satellite navigator.

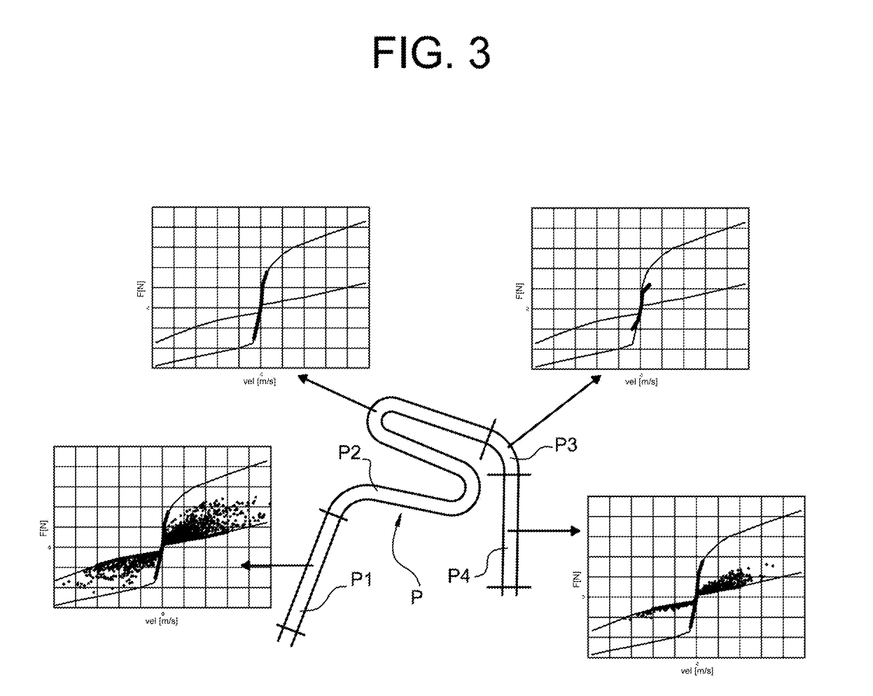

In FIG. 3, an example of the “Track Mode” customization level on a pre-established route “P” is set forth. The path is divided into elementary segments “P1”-“P4,” to each of which the user can associate a particular control configuration of the vehicle shock absorbers. For each identified segment, a “force-speed” diagram is reported for one of the vehicle shock absorbers, on which the minimum and maximum damping curves (curves with continuous length) are plotted, along with the scatter of “force-speed” points (asterisks) actually reached during the vehicle motion on the road length section under examination with the particular control configuration selected.

In a fourth customization level, called “Custom Set”, the vehicle shock absorbers assembly is adjusted in real time by the suspension system “processing and control” unit based on a predefined control logics. The user can modify the main parameters of this control strategy, so as to confer particular dynamic characteristics to the vehicle. For example, the user can modify the filtering out extent of the road irregularities allowed by the suspension system, modify the control level of the vehicle roll speed and the over-steering level in the curve transients, modify the control level of the pitch velocity in the longitudinal dynamics transients, and other parameters.

The system provides for further functions, compared to those set forth above, which allow an interaction of the user on the settings of the adjustment logics of the vehicle shock absorbers.

In the case where the device “T” is a satellite navigator, a “virtual sensor” function is provided. The device “T” transmits to the suspension system “processing and control” unit information about the vehicle dynamics and other predictive information about the path followed by the vehicle, typical of a navigation system, such as the monitoring of the current speeds and accelerations of the vehicle, the radii of curvature and the path slopes, the “road” functional class (functional class “Navteq”), the speed limits of the road length section travelled, and other ones.

Again, in the case where the device “T” is a satellite navigator, an “E-learning” function is provided, which allows associating a particular control configuration of the shock absorbers to a particular elementary segment of a preset path, to allow a customization of the “Track Mode” type.

Again, in the case where the device “T” is a satellite navigator, a function of identification of the “ride” style adopted by the driver is provided, based on the information about the vehicle dynamics and the road conditions acquired by the navigation unit “T.” In fact, by a comparison between the current vehicle motion characterized, for example, by the progression speed and the lateral and longitudinal accelerations, and the current characteristics of the travelled road, such as, for example, curvature radius and speed limits, it is possible to identify the “ride” style of the driver, in the terms of his higher or lower capability of a speeding driving, or a driving aimed to the ride comfort. The adjustment of the shock absorbers “damping” characteristics is therefore implemented by adopting an optimal correction of the several parameters of the control logics as a function of the identified “ride” style. In particular, the suspension system “processing and control” unit varies in real time the main parameters of the control logics, between those particular values which privilege the ride comfort and those particular values which privilege the speeding and ride precision. This is a further type of possible customization, with the aim of allowing a more efficient, even if automatic, adjustment based on parameters which are measurable or computable by a navigator device.

Suitably, a “monitoring” function is provided, according to which the device “T” is employed to display in real time to the user the current values of quantities relative to the vehicle motion, such as progressing speed, lateral and longitudinal accelerations, roll speed, pitch, body shake, relative speeds of the shock absorbers, vertical accelerations of the wheel hubs, and quantities relating to the adjustment operation of the shock absorbers characteristics, such as the control currents of the same.

Advantageously, a “data logging” function is further provided, according to which the temporal developments of the quantities listed in the preceding section, within predefined temporal ranges, are stored in suitable storage areas of the device “T,” in order to be subsequently displayed and processed by the user.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A control system of dynamics of a vehicle comprising:
a processing and control electronic unit (10) arranged to adjust predetermined parameters of at least one control function of the vehicle dynamics as a function of either of signals and data indicative of operative conditions of at least one of the vehicle and commands imparted by a driver and to generate either of command signals and data for relative actuator devices of said control function; and
an on-board telematics platform (30) interfaced with an on-board communication network operating according to a first predetermined transmission protocol for connection to said processing and control electronic unit (10) and adapted to establish a communication link (L) through a second predetermined transmission protocol with an autonomous portable personal electronic device (T) provided with respective input and output interface devices, arranged to allow inputting adjustment data of said control function, and adapted to display said adjustment data to a user,
wherein said processing and control electronic unit (10) is arranged to assume a first autonomous operative condition in which said processing and control electronic unit (10) is adapted to implement applications based on resident control strategies and a second coupled operative condition in which said processing and control electronic unit (10) is adapted to establish a communication with said telematics platform (30) to receive said adjustment data of said control function emitted by said portable personal electronic device (T) and, in said second coupled operative condition, said processing and control electronic unit (10) is arranged to actuate said control function based on said adjustment data received.

2. A control system as set forth in claim 1, wherein said telematics platform (30) and processing and control electronic unit (10) are interfaced with an on-board network on which other control units (11a-11e) are further interfaced.

3. A control system as set forth in claim 1, wherein said telematics platform (30) and processing and control electronic unit (10) are interfaced with a dedicated network for mutual said communication thereof.

4. A control system as set forth in claim 1, wherein said telematics platform (30) is integrated with said processing and control electronic unit (10).

5. A control system as set forth in claim 1, wherein said second predetermined transmission protocol for said communication between said telematics platform (30) and portable personal electronic device (T) is a Bluetooth® communication protocol.

6. A control system as set forth in claim 1, wherein said adjustment data are included within a predetermined range of values to ensure safeguard of safety conditions during maneuvers of the vehicle.

7. A control system as set forth in claim 1, wherein said adjustment data received by said processing and control electronic unit (10) in said second coupled operative condition are stored on board of said processing and control electronic unit (10).

8. A control system as set forth in claim 1, wherein said autonomous portable personal electronic device (T) includes a satellite navigation device provided with a satellite positioner bearing at least one reference geographical map, and adapted to compute vehicle localization data and said control system is arranged to create a mapping of adjustment characteristics of said control function managed as a function of a route travelled by the vehicle.

9. A control system as set forth in claim 8, wherein said adjustment data are stored in navigation device (T) in conjunction with said localization data.

10. A suspension system for a vehicle comprising:
a plurality of shock absorbers (14, 16) with adjustable damping each of which is provided with a control valve (24, 26) to control passage of a damping fluid between chambers of said shock absorber to modify relative damping force;
a set of sensors (12) adapted to detect either of relative acceleration and movement between a body of the vehicle and wheel hubs arranged at front and rear axes of the vehicle; and
a processing and control electronic unit (10) to emit driving signals of said control valves (24, 26) as a function of at least signals of said sensors (12) indicative of dynamics of the vehicle based on predetermined control strategies,
wherein said processing and control electronic unit (10) assumes a first autonomous operative condition in which said processing and control electronic unit (10) is adapted to implement applications based on resident control strategies and a second coupled operative condition in which said processing and control electronic unit (10) is adapted to establish a communication according to a first predetermined transmission protocol with an on-board telematics platform (30) adapted to establish a communication link (L) through a second predetermined transmission protocol with an autonomous portable personal electronic device (T) provided with respective input and output interface devices to allow inputting adjustment data of at least one damping force characteristic of said shock absorbers (14, 16), said processing and control electronic unit (10) in said second coupled operative condition is adapted to receive said adjustment data and drive said control valves (24, 26) based on said adjustment data received, and said suspension system is adapted to implement a control system.

11. A suspension system as set forth in claim 10, wherein said adjustment data include at least one force-speed curve for each of said shock absorbers (14, 16).

12. A suspension system as set forth in claim 10, wherein said adjustment data include at least one predefined control strategy of said shock absorbers (14, 16).

13. A suspension system as set forth in claim 10, wherein said adjustment data include a plurality of predefined control strategies of said shock absorbers (14, 16) associated to respective segments (P1-P4) of a preset road path (P).

14. A suspension system as set forth in claim 10, wherein said adjustment data include parameters of a predefined control strategy of said shock absorbers (14, 16).

15. A suspension system as set forth in claim 13, wherein said processing and control electronic unit (10) is adapted to receive data from said portable personal electronic device (T) that are representative of said vehicle dynamics and data representative of conditions on said road path (P).

16. A suspension system as set forth in claim 13, wherein said processing and control electronic unit (10) is adapted to identify a ride style adopted by a driver of the vehicle based on information about said vehicle dynamics and road path (P) acquired by said portable personal electronic device (T) to adjust parameters of a predefined control strategy of said shock absorbers (14, 16).

17. A control system of traction of a vehicle comprising:
an actuator with adjustable parameters for either of propulsion and gear-shift control;
a set of sensors (12) adapted to detect operative conditions and commands imparted by a driver of the vehicle; and
electronic processor and control (10) adapted to receive and interpret either of signals and data emitted by said sensors (12) and emit driving signals of said actuator as a function of said either of signals and data of said sensors (12) based on predetermined control strategies,
wherein said processor and control (10) assume a first autonomous operative condition in which said processor and control (10) are adapted to implement applications based on resident control strategies and a second coupled operative condition in which said processor and control (10) are adapted to establish a communication according to a first predetermined transmission protocol with an on-board telematics platform (30) adapted to establish a communication link (L) through a second predetermined transmission protocol with an autonomous portable personal electronic device (T) provided with respective input and output interface devices arranged to allow inputting adjustment data of at least one adjustable parameter for said either of propulsion and gear-shift control, said processor and control (10) in said second coupled operative condition is adapted to receive said adjustment data and drive said actuator based on said adjustment data received, and said traction control system is adapted to implement a control system.

18. A control system of steering of a vehicle comprising:
an actuator with adjustable parameters for control of the steering;
a set of sensors (12) adapted to detect operative conditions of the vehicle and commands imparted by a driver of the vehicle; and
electronic processor and controller (10) adapted to receive and interpret either of signals and data emitted by said sensors (12) and emit driving signals of said actuator as a function of said either of signals and data of said sensors (12) based on predetermined control strategies,
wherein said processor and control (10) assume a first autonomous operative condition in which said processor and control (10) are adapted to implement applications based on resident control strategies and a second coupled operative condition in which said processor and control (10) are adapted to establish a communication according to a first predetermined transmission protocol with an on-board telematics platform (30) adapted to establish a communication link (L) through a second predetermined transmission protocol with an autonomous portable personal electronic device (T) provided with respective input and output interface devices arranged to allow inputting adjustment data of at least one adjustable parameter for the control of the steering said processor and control (10) in said second coupled operative condition is adapted to receive said adjustment data and drive said actuator based on said adjustment data received, and said steering control system is adapted to implement a control system.

19. A control system of braking action of a vehicle comprising:
an actuator with adjustable parameters for control of the braking action;
a set of sensors (12) adapted to detect operative conditions of the vehicle and commands imparted by a driver of the vehicle; and
electronic processor and control (10) adapted to receive and interpret either of signals and data emitted by said sensors (12) and emit driving signals of said actuator as a function of said either of signals and data of said sensors (12) based on predetermined control strategies,
wherein said processor and control (10) assume a first autonomous operative condition in which said processor and control (10) are adapted to implement applications based on resident control strategies and a second coupled operative condition in which said processor and control (10) are adapted to establish a communication according to a first predetermined transmission protocol with an on-board telematics platform (30) adapted to establish a communication link (L) through a second predetermined transmission protocol with an autonomous portable personal electronic device (T) provided with respective input and output interface devices arranged to allow inputting adjustment data of at least one adjustable parameter for the control of the braking action, said processor and control (10) in said second coupled operative condition is adapted to receive said adjustment data and drive said actuator based on said adjustment data received, and said braking-action control system is adapted to implement a control system.

20. A control system as set forth in claim 19, wherein said portable personal electronic device (T) is adapted to establish said communication link (L) through said second predetermined transmission protocol with said telematics platform (30) of the vehicle and programmed to allow inputting said adjustment data of a vehicle dynamics control function managed by said processor and control (10) connected to said telematics platform (30) in a vehicle dynamics control system.
